(19) United States
(12) Patent Application Publication
(10) Pub. No.: US 2026/0141282 A1
(43) Pub. Date: May 21, 2026

(54) UTILIZING A NEURAL NETWORK TO IMPROVE THE QUANTUM COMPUTING PROCESS

(71) Applicant: International Business Machines Corporation, Armonk, NY (US)

(72) Inventor: Johannes Greiner, Deckenpfronn (DE)

(21) Appl. No.: 18/950,932

(22) Filed: Nov. 18, 2024

(51) Int. Cl. G06N 10/60; G06N 3/047; G06N 3/08

(52) U.S. Cl. CPC G06N 10/60; G06N 3/047; G06N 3/08

(57) ABSTRACT

A method, system, and computer program product for utilizing a neural network to improve the quantum computing process. Quantum circuits are modeled as graphs, such as by representing each qubit as a node, and each quantum gate as an edge connecting the relevant qubit nodes, where the edge direction indicates the order of operations in the circuit. Furthermore, probability distributions outputted from a quantum computer based on running the quantum circuits are received. A neural network is then trained based on a sample data set (inputs) including the quantum circuits modeled as graphs as well as the probability distributions outputted from the quantum computer in order to predict a probability distribution outputted by the quantum computer based on running a quantum circuit. Such a predicted probability distribution is then used to improve the quantum computing process by enabling the construction of the quantum circuit to be simplified, etc.

### TECHNICAL FIELD

The present disclosure relates generally to quantum computing, and more particularly to utilizing a neural network to improve the quantum computing process, such as simplifying the construction of the quantum circuit, enabling the simulation of the quantum circuit with a significant number of qubits, improving the time in processing an iterative workload, verifying that a given quantum circuit has been run correctly on a specific quantum computer backend, etc.

### BACKGROUND

Quantum computing is an emergent field of cutting-edge computer science harnessing the unique qualities of quantum mechanics to solve problems beyond the ability of even the most powerful classical computers.

The field of quantum computing contains a range of disciplines, including quantum hardware and quantum algorithms. While still in development, quantum technology will soon be able to solve complex problems that supercomputers cannot solve or cannot solve fast enough.

By taking advantage of quantum physics, fully realized quantum computers would be able to process massively complicated problems at orders of magnitude faster than modern machines. For a quantum computer, challenges that might take a classical computer thousands of years to complete might be reduced to a matter of minutes.

Quantum computing utilizes quantum circuits, which are graphical representations of a sequence of quantum gates and measurements that perform a quantum computation. Quantum circuits are used to carry out unitary transformations on qubits. Qubits or quantum bits, are the basic unit of information in quantum computing. It is the quantum equivalent of the bit, or binary digit, used in classical computing.

In order to run quantum circuits on quantum computers, especially large quantum circuits (quantum circuits with a large depth, which corresponds to the count of time steps needed to execute all the gates in the quantum circuit), such quantum circuits need to be classically simplified which is a lengthy and difficult process to implement.

Furthermore, quantum circuits are often simulated to assist in developing algorithms, evaluating hardware, understanding noise resilience, etc. However, such simulators (software program that uses a classical computer to simulate the quantum operations of a quantum computer) have difficulty in simulating quantum circuits with a significant number of qubits (e.g., greater than 60 qubits). That is, due to the significant amount of classical resources required to simulate quantum circuits with a significant number of qubits (e.g., greater than 60 qubits), such quantum circuits may not be able to be simulated.

Additionally, quantum workloads, such as utility-scale iterative workloads, may take tens of hours to run from start to finish. Utility-scale iterative workloads are workloads that include tasks that are repeated until a desired outcome is achieved for quantum utility, which is when a quantum computer is able to reliably solve problems at a scale that is beyond the capabilities of traditional classical computers using brute force methods. As a result, processing such utility-scale iterative workloads requires lots of quantum processing unit time and parameter updates (parameters are variables that may be used to optimize a function, maximize an objective, or solve a specific problem).

Furthermore, given a quantum circuit, it is difficult to verify whether that quantum circuit has been run correctly on a specific backend of the quantum computer. The backend of the quantum computer is a simulator or a real quantum computer that runs quantum circuits and returns results.

As a result, the quantum computing process is subject to various shortcomings, such as the difficulty in simplifying large quantum circuits, simulating quantum circuits with a significant number of qubits, processing utility-scale iterative workloads, and verifying that the quantum circuit has been run correctly on a specific backend of the quantum computer.

### SUMMARY

In one embodiment of the present disclosure, a method for utilizing a neural network to improve quantum computing process comprises modeling quantum circuits as graphs. The method further comprises receiving probability distributions outputted from a quantum computer based on running the quantum circuits. The method additionally comprises training the neural network based on inputs comprising the graphs and the probability distributions in order to predict a probability distribution outputted by the quantum computer based on running a quantum circuit.

Furthermore, in one embodiment of the present disclosure, the inputs further comprise calibration data and qubit coupling maps.

Additionally, in one embodiment of the present disclosure, the trained neural network functions as a simulator to predict the probability distribution outputted by the quantum computer based on a graph of the quantum circuit.

Furthermore, in one embodiment of the present disclosure, the method additionally comprises comparing a probability distribution outputted by the quantum computer based on running a parameterized quantum circuit with probability distributions predicted by the trained neural network to be outputted by the quantum computer based on running updated parameterized quantum circuits to select one of the updated parameterized quantum circuits to be run on the quantum computer in a next run.

Additionally, in one embodiment of the present disclosure, the method further comprises simplifying a construction of the quantum circuit to form a modified quantum circuit based on the predicted probability distribution outputted by the quantum computer using one or more of the following methods in the group consisting of: light-cone method, circuit cutting and forging technique, and Clifford circuit approximation.

Furthermore, in one embodiment of the present disclosure, the method additionally comprises comparing the probability distribution predicted by the trained neural network to be outputted by the quantum computer based on running the quantum circuit with a probability distribution predicted by the trained network to be outputted by the quantum computer based on running a modified quantum circuit for verifying that the modified quantum circuit correctly modified the quantum circuit.

Additionally, in one embodiment of the present disclosure, the method further comprises comparing a probability distribution outputted by the quantum computer based on running the quantum circuit with the probability distribution predicted by the trained neural network to be outputted by the quantum computer based on running the quantum circuit for verifying that the neural network was trained using a same quantum computer backend as used by the quantum computer.

Furthermore, in one embodiment of the present disclosure, the method additionally comprises creating an intermediate layer of the neural network to model a density matrix of the quantum computer. The method further comprises filtering a result based on outputs summing to 1.

Other forms of the embodiments of the method described above are in a system and in a computer program product.

Accordingly, embodiments of the present disclosure improve the quantum computing process by utilizing a trained neural network to predict the probability distribution outputted by a quantum computer based on running a quantum circuit thereby enabling the construction of the quantum circuit to be simplified, enabling the simulation of the quantum circuit with a significant number of qubits, improving the time in processing an iterative workload, verifying that a given quantum circuit has been run correctly on a specific quantum computer backend, etc.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for improving the quantum computing process by training a neural network to predict a probability distribution outputted by a quantum computer based on running a quantum circuit in accordance with an embodiment of the present disclosure;

FIG. 3 illustrates training a neural network based on quantum circuits modeled as graphs and probability distributions outputted by a quantum computer based on running quantum circuits in accordance with an embodiment of the present disclosure;

FIG. 4 illustrates the trained neural network predicting outcomes of the quantum computer running the quantum circuit in accordance with an embodiment of the present disclosure;

FIG. 5 illustrates simplifying the construction of the quantum circuit based on the probability distribution predicted by the trained neural network in accordance with an embodiment of the present disclosure;

FIG. 6 illustrates verifying that the modified quantum circuit correctly modifies the quantum circuit in accordance with an embodiment of the present disclosure;

FIG. 7 illustrates verifying that the quantum circuit has been run correctly on a specific backend of the quantum computer in accordance with an embodiment of the present disclosure;

FIG. 8 illustrates the trained neural network selecting the best parameterized quantum circuit to run on the quantum computer for processing the iterative workload in accordance with an embodiment of the present disclosure;

FIG. 9 illustrates an embodiment of the present disclosure of the hardware configuration of the classical computer which is representative of a hardware environment for practicing the present disclosure;

FIG. 10 is a flowchart of a method for training a neural network to predict the probability distribution of a quantum computer in accordance with an embodiment of the present disclosure; and

FIG. 11 is a flowchart of a method for utilizing a trained neural network to improve the quantum computing process in accordance with an embodiment of the present disclosure.

### DETAILED DESCRIPTION

In one embodiment of the present disclosure, a method for utilizing a neural network to improve quantum computing process comprises modeling quantum circuits as graphs. The method further comprises receiving probability distributions outputted from a quantum computer based on running the quantum circuits. The method additionally comprises training the neural network based on inputs comprising the graphs and the probability distributions in order to predict a probability distribution outputted by the quantum computer based on running a quantum circuit.

In this manner, the quantum computing process is improved by utilizing a trained neural network to predict the probability distribution outputted by a quantum computer based on running a quantum circuit thereby enabling the construction of the quantum circuit to be simplified, enabling the simulation of the quantum circuit with a significant number of qubits, improving the time in processing an iterative workload, verifying that a given quantum circuit has been run correctly on a specific quantum computer backend, etc.

Furthermore, in one embodiment of the present disclosure, the inputs further comprise calibration data and qubit coupling maps.

In this manner, the neural network can be trained to predict the probability distribution outputted by the quantum computer based on running the quantum circuit by further utilizing calibration data and qubit coupling maps, such as in the form of a graph.

Additionally, in one embodiment of the present disclosure, the trained neural network functions as a simulator to predict the probability distribution outputted by the quantum computer based on a graph of the quantum circuit.

In this manner, the trained neural network of the present disclosure improves the quantum computing process by functioning as a simulator so as to enable the simulation of the quantum circuit with a significant number of qubits.

Furthermore, in one embodiment of the present disclosure, the method additionally comprises comparing a probability distribution outputted by the quantum computer based on running a parameterized quantum circuit with probability distributions predicted by the trained neural network to be outputted by the quantum computer based on running updated parameterized quantum circuits to select one of the updated parameterized quantum circuits to be run on the quantum computer in a next run.

In this manner, the trained neural network of the present disclosure improves the quantum computing process by improving the time in processing an iterative workload, such as a utility-scale iterative workload, by selecting the best updated parameterized quantum circuit to be run on the quantum computer in the next run.

Additionally, in one embodiment of the present disclosure, the method further comprises simplifying a construction of the quantum circuit to form a modified quantum circuit based on the predicted probability distribution outputted by the quantum computer using one or more of the following methods in the group consisting of: light-cone method, circuit cutting and forging technique, and Clifford circuit approximation.

In this manner, the trained neural network of the present disclosure improves the quantum computing process by enabling the simplification of the construction of the quantum circuit.

Furthermore, in one embodiment of the present disclosure, the method additionally comprises comparing the probability distribution predicted by the trained neural network to be outputted by the quantum computer based on running the quantum circuit with a probability distribution predicted by the trained network to be outputted by the quantum computer based on running a modified quantum circuit for verifying that the modified quantum circuit correctly modified the quantum circuit.

In this manner, the trained neural network of the present disclosure improves the quantum computing process by verifying that the modified quantum circuit correctly modified the quantum circuit.

Additionally, in one embodiment of the present disclosure, the method further comprises comparing a probability distribution outputted by the quantum computer based on running the quantum circuit with the probability distribution predicted by the trained neural network to be outputted by the quantum computer based on running the quantum circuit for verifying that the neural network was trained using a same quantum computer backend as used by the quantum computer.

In this manner, the trained neural network of the present disclosure improves the quantum computing process by verifying that the neural network was trained using the same quantum computer backend as used by the quantum computer.

Furthermore, in one embodiment of the present disclosure, the method additionally comprises creating an intermediate layer of the neural network to model a density matrix of the quantum computer. The method further comprises filtering a result based on outputs summing to 1.

In this manner, the neural network can be created with an intermediate layer that can model the density matrix of the system in order to ensure successful neural network implementation.

Other forms of the embodiments of the method described above are in a system and in a computer program product.

As stated above, quantum computing utilizes quantum circuits, which are graphical representations of a sequence of quantum gates and measurements that perform a quantum computation. Quantum circuits are used to carry out unitary transformations on qubits. Qubits or quantum bits, are the basic unit of information in quantum computing. It is the quantum equivalent of the bit, or binary digit, used in classical computing.

In order to run quantum circuits on quantum computers, especially large quantum circuits (quantum circuits with a large depth, which corresponds to the count of time steps needed to execute all the gates in the quantum circuit), such quantum circuits need to be classically simplified which is a lengthy and difficult process to implement.

Furthermore, quantum circuits are often simulated to assist in developing algorithms, evaluating hardware, understanding noise resilience, etc. However, such simulators (software program that uses a classical computer to simulate the quantum operations of a quantum computer) have difficulty in simulating quantum circuits with a significant number of qubits (e.g., greater than 60 qubits). That is, due to the significant amount of classical resources required to simulate quantum circuits with a significant number of qubits (e.g., greater than 60 qubits), such quantum circuits may not be able to be simulated.

Additionally, quantum workloads, such as utility-scale iterative workloads, may take tens of hours to run from start to finish. Utility-scale iterative workloads are workloads that include tasks that are repeated until a desired outcome is achieved for quantum utility, which is when a quantum computer is able to reliably solve problems at a scale that is beyond the capabilities of traditional classical computers using brute force methods. As a result, processing such utility-scale iterative workloads requires lots of quantum processing unit time and parameter updates (parameters are variables that may be used to optimize a function, maximize an objective, or solve a specific problem).

Furthermore, given a quantum circuit, it is difficult to verify whether that quantum circuit has been run correctly on a specific backend of the quantum computer. The backend of the quantum computer is a simulator or a real quantum computer that runs quantum circuits and returns results.

As a result, the quantum computing process is subject to various shortcomings, such as the difficulty in simplifying large quantum circuits, simulating quantum circuits with a significant number of qubits, processing utility-scale iterative workloads, and verifying that the quantum circuit has been run correctly on a specific backend of the quantum computer.

The embodiments of the present disclosure provide the means for improving the quantum computing process by training a neural network to predict a probability distribution outputted by a quantum computer based on running a quantum circuit, where such a probability distribution can be used to simplify the construction of the quantum circuit. Furthermore, in one embodiment, the trained neural network functions as a simulator thereby enabling the simulation of quantum circuits with a significant number of qubits. Additionally, in one embodiment, based on the probability distributions predicted by the trained neural network to be outputted by the quantum computer based on running updated parameterized quantum circuits and the probability distribution outputted by the quantum computer based on running the parameterized quantum circuit, one of the updated parameterized quantum circuits is selected with a predicted probability distribution that is most similar to the probability distribution outputted by the quantum computer. Such a selected updated parameterized quantum circuit corresponds to the parameterized quantum circuit to be run on the quantum computer in the next run so as to improve the time for processing a long-running workflow, such as a utility-scale iterative workflow. Furthermore, in one embodiment, the probability distribution predicted by the trained neural network based on running the quantum circuit on the quantum computer is compared with the probability distribution outputted by the quantum computer based on running the quantum circuit. Such a comparison is performed in order to determine if such probability distributions are close enough to verify that the neural network was trained on the same quantum computer backend as was used by the quantum computer to output its probability distribution. These and other features will be discussed in further detail below.

While the following discusses the present disclosure in connection with predicting probability distributions, the principles of the present disclosure may apply to predicting expectation values (expectation value is the predicted average value of a measurement based on an infinite number of measurements on identical systems). A person of ordinary skill in the art would be capable of applying the principles of the present disclosure to such implementations. Furthermore, embodiments applying the principles of the present disclosure to such implementations would fall within the scope of the present disclosure.

In some embodiments of the present disclosure, the present disclosure comprises a method, system, and computer program product for utilizing a neural network to improve the quantum computing process. In one embodiment of the present disclosure, quantum circuits are modeled as graphs. In one embodiment, quantum circuits are modeled as graphs by representing each qubit as a node, and each quantum gate as an edge connecting the relevant qubit nodes, where the edge direction indicates the order of operations in the circuit. Furthermore, probability distributions outputted from a quantum computer based on running the quantum circuits is received. A probability distribution, as used herein, refers to a mathematical function that describes the likelihood of different possible outcomes for a given input, i.e., representing a range of potential predictions. A neural network is then trained based on a sample data set (inputs) including the quantum circuits modeled as graphs as well as the probability distributions outputted from the quantum computer in order to predict a probability distribution outputted by a quantum computer based on running a quantum circuit. Such a predicted probability distribution by the trained neural network is then used to improve the quantum computing process by enabling the construction of the quantum circuit to be simplified, enabling the simulation of the quantum circuit with a significant number of qubits, improving the time in processing an iterative workload, verifying that a given quantum circuit has been run correctly on a specific quantum computer backend, etc.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

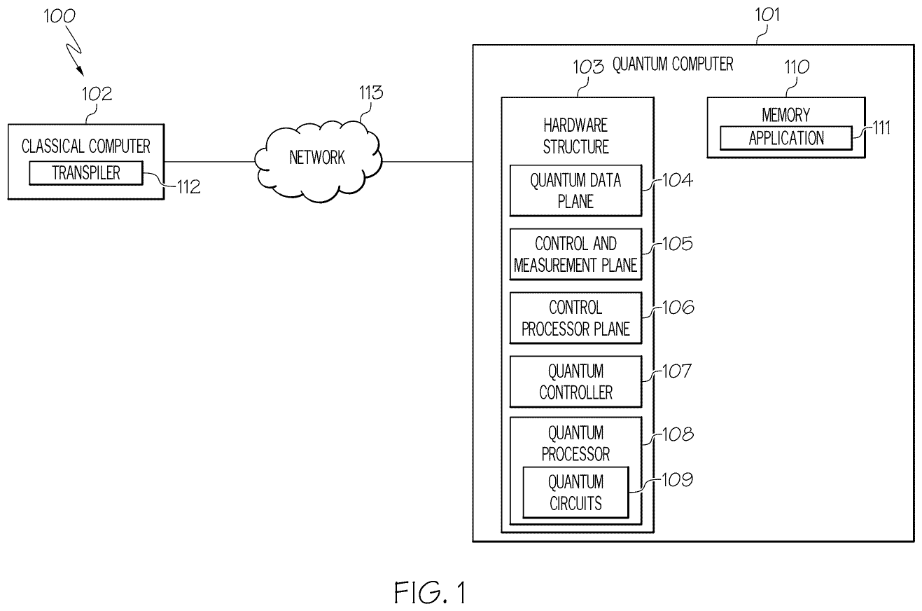

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to improve the quantum computing process by training a neural network to predict a probability distribution outputted by a quantum computer based on running a quantum circuit.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits'state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

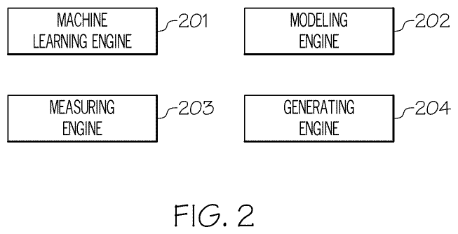

In one embodiment, memory 110 stores an application 111 that may be configured to implement one or more of the methods described herein in accordance with one or more embodiments. For example, application 111 may implement a program for improving the quantum computing process by training a neural network to predict a probability distribution outputted by a quantum computer based on running a quantum circuit as discussed further below in connection with FIGS. 2-8 and 10-11. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit. transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

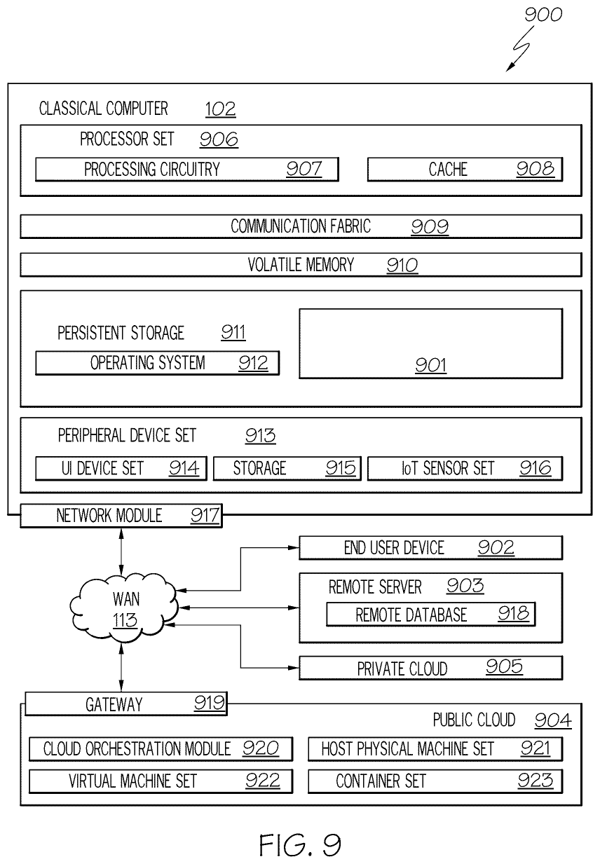

Furthermore, classical computer 102 is configured to improve the quantum computing process by training a neural network to predict a probability distribution outputted by a quantum computer based on running a quantum circuit as discussed further below in connection with FIGS. 2-8 and 10-11. A description of the software components of classical computer 102 is provided below in connection with FIG. 2 and a description of the hardware configuration of classical computer 102 is provided further below in connection with FIG. 9.

System 100 is not to be limited in scope to any one particular network architecture. System 100 may include any number of quantum computers 101, classical computers 102, and networks 113.

A discussion regarding the software components used by classical computer 102 for improving the quantum computing process by training a neural network to predict a probability distribution outputted by a quantum computer (e.g., quantum computer 101) based on running a quantum circuit (e.g., quantum circuit 109) is provided below in connection with FIG. 2.

FIG. 2 is a diagram of the software components of classical computer 102 (FIG. 1) for improving the quantum computing process by training a neural network to predict a probability distribution outputted by a quantum computer (e.g., quantum computer 101) based on running a quantum circuit (e.g., quantum circuit 109) in accordance with an embodiment of the present disclosure.

Referring to FIG. 2, in conjunction with FIG. 1, classical computer 102 includes machine learning engine 201 configured to build and train a neural network based on a sample data set to predict a probability distribution outputted by a quantum computer (e.g., quantum computer 101) based on running a quantum circuit (e.g., quantum circuit 109). A probability distribution, as used herein, refers to a mathematical function that describes the likelihood of different possible outcomes for a given input, i.e., representing a range of potential predictions.

In one embodiment, such a sample data set includes quantum circuits modeled as graphs. In one embodiment, classical computer 102 includes modeling engine 202 configured to model quantum circuits as graphs. In one embodiment, modeling engine 202 models quantum circuits (e.g., quantum circuits 109) as graphs by representing each qubit as a node, and each quantum gate as an edge connecting the relevant qubit nodes, where the edge direction indicates the order of operations in the circuit, essentially treating the circuit diagram as a directed acyclic graph (DAG) with the flow of information from left to right. In such an embodiment, each gate will be connected to the qubits it operates on as input and output nodes.

In one embodiment, modeling engine 202 models the quantum circuits (e.g., quantum circuits 109) as graphs using various software tools, such as, but not limited to, transpiler 112.

Furthermore, in one embodiment, the sample data set includes the probability distributions outputted by a quantum computer (e.g., quantum computer 101) based on running the quantum circuits, such as the quantum circuits modeled as graphs. In one embodiment, machine learning engine 201 obtains the probability distributions outputted from the quantum computer from measuring engine 203 of classical computer 102 by measuring engine 203 measuring the quantum state, where the probability of each possible outcome is directly related to the square of the amplitude of the corresponding quantum state vector. In one embodiment, measuring engine 203 utilizes various software tools for measuring the probability distributions outputted by the quantum computer based on running quantum circuits, such as, but not limited to, Qiskit, ®, Cirq®, ProjectQ, etc.

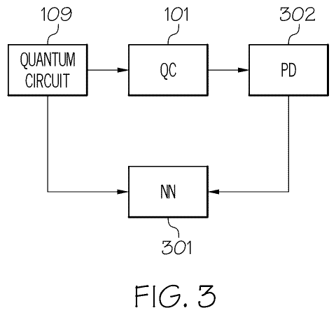

An illustration of training a neural network based on such sample data (graphs of quantum circuits and probability distributions outputted by a quantum computer based on running such quantum circuits) is provided in FIG. 3.

Referring to FIG. 3, FIG. 3 illustrates training a neural network based on quantum circuits (e.g., quantum circuits 109) modeled as graphs and probability distributions outputted by a quantum computer based on running quantum circuits in accordance with an embodiment of the present disclosure.

As shown in FIG. 3, neural network (NN) 301 is trained based on quantum circuits 109 modeled as graphs and probability distributions (PD) 302 outputted by quantum computer (QC) 101 based on running quantum circuits 109 that were modeled as graphs.

Returning to FIG. 2, in conjunction with FIGS. 1 and 3, in one embodiment, the sample data set further includes calibration data (e.g., readout errors, 2-qubit errors, etc.) and a qubit coupling map (e.g., coupling graph of the specific quantum computer backend), such as in the form of a graph. For example, the sample data set may further include the qubit coupling map of a specific quantum computer backend, weighted with current calibration data.

Calibration data, as used herein, refers to information collected about the performance of quantum computer 101 during calibration, which is used to adjust the parameters of the quantum gates and qubits to improve the fidelity (measure of how closely a quantum state or operation matches its intended or ideal state or operation) of quantum operations. In one embodiment, machine learning engine 201 obtains such calibration data from measuring engine 203 based on measuring engine 203 monitoring the performance of quantum computer 101 during calibration using techniques, such as randomized benchmarking (RB) and quantum process tomography, to measure the fidelity of quantum gates, and analyzing metrics from such monitored performance, such as error rates and qubit coherence times, while observing the data through the quantum computer's control interface to identify any anomalies or drifts in performance across individual qubits and gate operations. This allows for adjustments to calibration parameters to optimize the system's overall performance. In one embodiment, measuring engine 203 measures such calibration data in such a manner using various software tools including, but are not limited to, Cirq®, Qiskit®, Qibocal, etc.

A qubit coupling map, as used herein, refers to a directed graph that shows which qubits can interact with each other in quantum computer 101. In one embodiment, the nodes in the qubit coupling map represent physical qubits and the directed edges represent permitted CNOT gates. In one embodiment, machine learning engine 201 uses the CouplingMap function of Qiskit® to generate such a qubit coupling map for quantum hardware (e.g., quantum computer 101).

In one embodiment, the sample data set, discussed herein, is obtained by an expert, such as a developer.

Furthermore, in one embodiment, the sample data set discussed above is referred to herein as the “training data,” which is used by a machine learning algorithm to make predictions or decisions, such as the predicted probability distribution outputted by a quantum computer (e.g., quantum computer 101) based on running a quantum circuit (e.g., quantum circuit 109). In one embodiment, as discussed further below, the trained neural network predicts the probability distribution outputted by the quantum computer (e.g., quantum computer 101) based on the input of the quantum circuit being modeled as a graph. The algorithm iteratively makes predictions on the training data until the predictions achieve the desired accuracy as determined by an expert.

In one embodiment, machine learning engine 201 creates an intermediate layer in the neural network (e.g., neural network 301) to model a density matrix of the quantum computer (e.g., quantum computer 101). A density matrix, as used herein, is a matrix that represents quantum states in quantum computing and quantum mechanics. It is a generalization of wavefunctions and state vectors, which can only represent pure states, while density matrices can also represent mixed ensembles. In such a density matrix, the diagonal entries of the density matrix represent the probabilities of each classical state appearing in a standard basis measurement. The off-diagonal entries describe the degree to which the two classical states corresponding to that entry are in quantum superposition. In one embodiment, machine learning engine 201 creates such an intermediate layer using various software tools, including, but are not limited to, IBM® Quantum Platform®, Intel® Quantum Simulator, Cirq®, etc.

In one embodiment, machine learning engine 201 takes into consideration the constraints (e.g., positive semidefinite, trace(matrix)=1) of a correct (physical) density by adding an additional (filter) layer.

In one embodiment, machine learning engine 201 adds an additional layer to model the transformation on the density matrix due to noise, such as in the Kraus channel. The Kraus representation of a quantum channel is a collection of matrices that describe how the density matrix evolves.

In one embodiment, machine learning engine 201 filters the results of the neural network (e.g., neural network 301) based on outputs summing to 1. In one embodiment, such filtering occurs in a final filter layer to ensure that a correct probability distribution is outputted by the quantum computer.

Upon training the neural network (e.g., neural network 301), the trained neural network predicts the probability distribution outputted by the quantum computer (e.g., quantum computer 101) based on the input of the quantum circuit being modeled as a graph.

In one embodiment, modeling engine 202 models the quantum circuit to be inputted to the trained neural network as a graph. As discussed above, in one embodiment, modeling engine 202 models the quantum circuit (e.g., quantum circuit 109) as a graph by representing each qubit as a node, and each quantum gate as an edge connecting the relevant qubit nodes, where the edge direction indicates the order of operations in the circuit, essentially treating the circuit diagram as a directed acyclic graph (DAG) with the flow of information from left to right. In such an embodiment, each gate will be connected to the qubits it operates on as input and output nodes.

In one embodiment, modeling engine 202 models the quantum circuit (e.g., quantum circuit 109) as a graph using various software tools, such as, but not limited to, transpiler 112.

In one embodiment, modeling engine 202 transpiles the quantum circuit against a specific quantum computer backend. A quantum computer backend, as used herein, is a simulator or real quantum computer that runs quantum circuits and returns results. Backends can have properties that change when calibrated, such as qubit frequency and operation error rates.

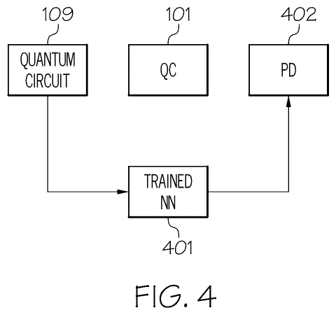

Classical computer 102 further includes generating engine 204 configured to generate a probability distribution predicted to be outputted by the quantum computer (e.g., quantum computer 101) using the trained neural network based on the graph of the quantum circuit (e.g., 109), including a quantum circuit that was transpiled against a specific quantum computer backend, as illustrated in FIG. 4.

FIG. 4 illustrates the trained neural network predicting outcomes of the quantum computer running the quantum circuit in accordance with an embodiment of the present disclosure.

Referring to FIG. 4, in conjunction with FIGS. 2-3, the trained neural network 401 receives the graph of quantum circuit 109, including the graph of the quantum circuit transpiled against a specific quantum computer backend. Upon receiving such an input, the trained neural network (NN) 401 outputs the probability distribution (PD) 402 predicted to be outputted by quantum computer 101 based on running such a quantum circuit.

In this manner, the trained neural network (e.g., trained neural network 401) functions as a simulator to predict the probability distribution outputted by the quantum computer (e.g., quantum computer 101) based on the modeled quantum circuit (modeled as a graph). As a result, results for large quantum circuits may now be able to be predicted for such quantum circuits that were not previously simulatable. For example, quantum circuits with a significant number of qubits (e.g., greater than 60 qubits) may not previously have been able to be simulated due to the significant amount of required classical resources. Such quantum circuits with a significant number of qubits may now be able to be simulated via the trained neural network (e.g., trained neural network 401).

Furthermore, in this manner, by predicting the probability distribution 402 outputted by quantum computer 101, such a probability distribution may be used to simplify the construction of the quantum circuit (e.g., quantum circuit 109).

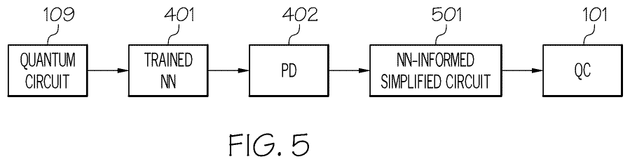

For example, in one embodiment, generating engine 204 simplifies the construction of the quantum circuit (e.g., quantum circuit 109) to form a modified quantum circuit based on the predicted probability distribution as discussed below in connection with FIG. 5.

FIG. 5 illustrates simplifying the construction of the quantum circuit based on the probability distribution predicted by the trained neural network in accordance with an embodiment of the present disclosure.

As shown in FIG. 5, generating engine 204 generates a modified quantum circuit 501 with a simpler design than quantum circuit 109 based on the probability distribution 402 predicted by the trained neural network 401.

In one embodiment, generating engine 204 simplifies the construction of quantum circuit 109 to form modified quantum circuit 501 based on the predicted probability distribution 402 using one or more of the following methods: light-cone method, circuit cutting and forging technique, and Clifford circuit approximation.

The light-cone method, as used herein, refers to a technique, based on the concept of a light cone from special relativity, used to limit calculations to events that can influence each other within a specific boundary thereby allowing for more efficient computation (reduction in the number of qubits) by restricting the relevant interactions within the system.

The circuit cutting and forging technique is a technique to break down quantum circuits into smaller circuits that can be run on quantum hardware. Circuit cutting is the technique to break down a quantum circuit into smaller circuits by cutting its wires and gates. The results of the smaller circuits are then combined to reconstruct the original circuit's outcome. Circuit cutting can also be used to engineer gates between distant qubits.

Entanglement forging is a technique that allows a larger circuit to be cut into smaller circuits that can be run on smaller hardware. Smaller circuits are easier to execute and can tolerate more noise.

Clifford approximation, as used herein, refers to a method for approximating quantum circuits using a restricted class of quantum circuits called Clifford circuits.

Generating engine 204 uses various software tools for simplifying the construction of quantum circuit 109 to form modified quantum circuit 501 based on the probability distribution predicted by the trained neural network 401, including, but are not limited to, ProjectQ, Cirq®, Qiskit®, PennyLane®, IBM® Quantum Platform®, etc.

By being able to simplify the construction of quantum circuits, large quantum circuits (quantum circuits with a large depth, which corresponds to the count of time steps needed to execute all the gates in the quantum circuit) may be more accessible to current quantum hardware.

Furthermore, by training the neural network (e.g., trained neural network 401) to predict the probability distribution outputted by the quantum computer (e.g., quantum computer 101), it can be verified that modified quantum circuit 501 (e.g., quantum circuit modified by circuit cutting and forging technique) is accurate without needing to access the quantum computer.

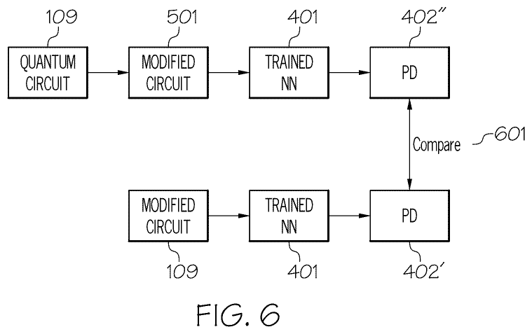

For example, the probability distribution predicted by the trained neural network (e.g., trained neural network 401) for both modified quantum circuit 501 and the non-modified quantum circuit 109 can be compared. If such a difference is below a threshold value, which may be user-designated, then it may be concluded that modified quantum circuit 501 correctly modified quantum circuit 109 as discussed below in connection with FIG. 6.

FIG. 6 illustrates verifying that the modified quantum circuit (e.g., modified quantum circuit 501) correctly modifies the quantum circuit (e.g., quantum circuit 109), such as by simplifying the construction of the quantum circuit, in accordance with an embodiment of the present disclosure.

Referring to FIG. 6, in conjunction with FIGS. 2-5, generating engine 204 compares (see element 601) the probability distribution 402′ predicted by the trained neural network (e.g., trained neural network 401) for the quantum circuit 109 with the probability distribution 402″ predicted by the trained neural network (e.g., trained neural network 401) for modified quantum circuit 501. As previously discussed, modified quantum circuit 501 is a simplified version of quantum circuit 109, which was simplified using the light-cone method, the circuit cutting and forgoing technique, or the Clifford circuit approximation.

In one embodiment, generating engine 204 performs such a comparison by calculating the Hellinger distance, such as by using the hellinger1 program or the function qiskit.quantum_info.hellinger_fidelity in Qiskit®, which is used to quantify the similarity between two probability distributions. If the Hellinger distance is below a threshold value, which may be user-designated, then it may be concluded that modified quantum circuit 501 correctly modified quantum circuit 109.

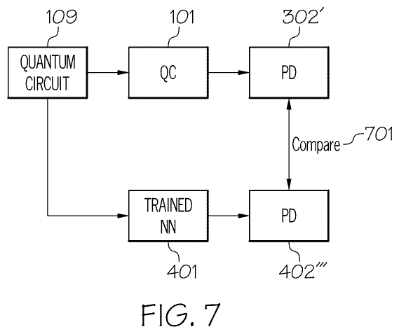

Furthermore, by training the neural network (e.g., trained neural network 401) to predict the probability distribution outputted by the quantum computer (e.g., quantum computer 101), it can be verified that the neural network was trained (e.g., trained neural network 401) using the same quantum computer backend as used by the quantum computer as discussed below in connection with FIG. 7.

FIG. 7 illustrates verifying that the quantum circuit has been run correctly on a specific backend of the quantum computer in accordance with an embodiment of the present disclosure.

Referring to FIG. 7, in conjunction with FIGS. 2-5, generating engine 204 compares (see element 701) the probability distribution 302′ outputted by quantum computer 101 based on quantum circuit 109 running on quantum computer 101 with the probability distribution 402″′ predicted by the trained neural network (e.g., trained neural network 401) based on receiving a graph of the modeled quantum circuit 109, which may have been transpiled against a specific computer backend.

In one embodiment, generating engine 204 performs such a comparison by calculating the Hellinger distance, such as by using the hellinger1 program or the function qiskit.quantum_info.hellinger_fidelity in Qiskit®, which is used to quantify the similarity between two probability distributions. If the Hellinger distance is below a threshold value, which may be user-designated, then it may be concluded that the probability distribution (e.g., probability distribution 402″′) predicted by the trained neural network was trained on the same quantum computer backend as was used by quantum computer 101 to output its probability distribution.

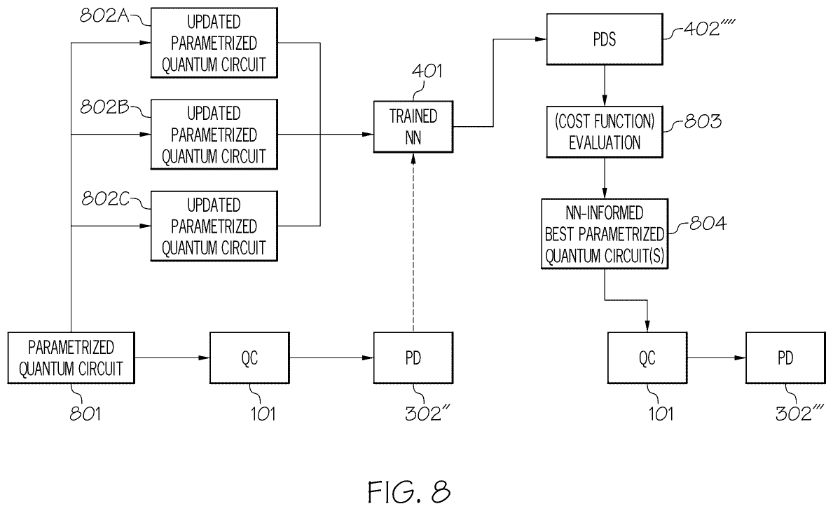

Furthermore, by training the neural network (e.g., trained neural network 401) to predict the probability distribution outputted by the quantum computer (e.g., quantum computer 101), such predictions for updated parameterized quantum circuits may be utilized for selecting the best updated parameterized quantum circuit to be run on the quantum computer (e.g., quantum computer 101) in the next run so as to improve the time for processing a long-running workflow, such as a utility-scale iterative workflow, as discussed below in connection with FIG. 8.

FIG. 8 illustrates the trained neural network (e.g., trained neural network 401) selecting the best parameterized quantum circuit to run on the quantum computer for processing the iterative workload, such as a utility-scale iterative workload, in accordance with an embodiment of the present disclosure.

Referring to FIG. 8, in conjunction with FIGS. 2-4, the trained neural network (e.g., neural network 401) receives as inputs, updated parameterized quantum circuits 802A-802C, which have parameters updated from an original parameterized quantum circuit 801. Updated parameterized quantum circuits 802A-802C may collectively or individually be referred to as updated parameterized quantum circuits 802 or updated parameterized quantum circuit 802, respectively. While FIG. 8 illustrates three updated parameterized quantum circuits 802, any number of updated parameterized quantum circuits 802 may be inputted to the trained neural network (e.g., neural network 401).

A parameterized quantum circuit 801, 802, as used herein, is a quantum circuit that contains both fixed and adjustable gates. The adjustable gates, or parameters, can be changed during computation to solve problems or perform tasks. An updated parameterized quantum circuit 802 corresponds to parameterized quantum circuit 801 with an update to one or more parameters of parameterized quantum circuit 801.

In one embodiment, modeling engine 202 models updated parameterized quantum circuits 802 as graphs in the same manner as modeling quantum circuit 109 as a graph discussed above. Upon receiving such graphs as inputs, the trained neural network (e.g., neural network 401) outputs predicted probability distributions 402″″ for each updated parameterized quantum circuit 802 which are evaluated against the probability distribution 302″ outputted by quantum computer 101 running parameterized quantum circuit 801, such as on the first run.

In one embodiment, such an evaluation is performed by generating engine 204 using a cost function 803, which is a measure of how well a model fits the data and how close its predictions are to the desired outcomes. The cost function is used to evaluate the probability distributions predicted by the trained neural network (e.g., neural network 401) for each of the inputted updated parameterized quantum circuits 802 in comparison to the probability distribution outputted by quantum computer 101. The closer such probability distributions, the closer the associated updated parameterized quantum circuit 802 is to the original parameterized quantum circuit 801, which should be used in further iterations to process the iterative workflow in order to improve the time for processing long-running workflows, such as utility-scale iterative workflows. Examples of cost functions utilized by generating engine 204 to evaluate how close the probability distributions predicted by the trained neural network (e.g., neural network 401) for each of the inputted updated parameterized quantum circuits 802 is to the probability distribution outputted by quantum computer 101 include, but are not limited to, Kullback-Leibler divergence (KLD), Jensen-Shannon Divergence, Wasserstein Distance, Kolmogorov-Smirnov Test, Chi-Squared Test, etc.

After identifying one of the updated parameterized quantum circuits 802A-802C with its predicted probability distribution 402″″ as most closely matching the probability distribution 302″ outputted by quantum computer 101, such an identified updated parameterized quantum circuit 802 is selected as the best parameterized quantum circuit 804 to be utilized by quantum computer 101 in its next run in processing the iterative workload (e.g., utility-scale iterative workflow). Quantum computer 101 then runs the best parameterized quantum circuit 804 in the next run thereby outputting probability distribution 302″″.

It is noted that such a probability distribution 302″′ may be evaluated against the updated parameterized quantum circuits 802A-802C with its predicted probability distribution 402″″ in the next run to determine if parameterized quantum circuit 804 is still the best parameterized quantum circuit to be utilized by quantum computer 101 in its next run in processing the iterative workload (e.g., utility-scale iterative workflow). By selecting the best parameterized quantum circuit to process long-running algorithms, the time for processing long-running workflows, such as utility-scale iterative workflows, is improved.

In this manner, the shortcomings to the quantum computing process are overcome, such as overcoming the difficulty in simplifying large quantum circuits, simulating quantum circuits with a significant number of qubits, processing utility-scale iterative workloads, and verifying that the quantum circuit has been run correctly on a specific backend of the quantum computer.

A further description of these and other functions is provided below in connection with the discussion of the method for improving the quantum computing process by training a neural network to predict a probability distribution outputted by a quantum computer based on running a quantum circuit.

Prior to the discussion of the method for improving the quantum computing process by training a neural network to predict a probability distribution outputted by a quantum computer based on running a quantum circuit, a description of the hardware configuration of classical computer 102 (FIG. 1) is provided below in connection with FIG. 9.

Referring now to FIG. 9, in conjunction with FIG. 1, FIG. 9 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code 901 involved in performing the inventive methods, such as improving the quantum computing process by training a neural network to predict a probability distribution outputted by a quantum computer based on running a quantum circuit. In addition to block 901, computing environment 900 includes, for example, classical computer 102, network 113, such as a wide area network (WAN), end user device (EUD) 902, remote server 903, public cloud 904, and private cloud 905. In this embodiment, classical computer 102 includes processor set 906 (including processing circuitry 907 and cache 908), communication fabric 909, volatile memory 910, persistent storage 911 (including operating system 912 and block 901, as identified above), peripheral device set 913 (including user interface (UI) device set 914, storage 915, and Internet of Things (IoT) sensor set 916), and network module 917. Remote server 903 includes remote database 918. Public cloud 904 includes gateway 919, cloud orchestration module 920, host physical machine set 921, virtual machine set 922, and container set 923.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 918. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically classical computer 102, to keep the presentation as simple as possible. Classical computer 102 may be located in a cloud, even though it is not shown in a cloud in FIG. 9. On the other hand, classical computer 102 is not required to be in a cloud except to any extent as may be affirmatively indicated.

Processor set 906 includes one, or more, computer processors of any type now known or to be developed in the future. Processing circuitry 907 may be distributed over multiple packages, for example, multiple, coordinated integrated circuit chips. Processing circuitry 907 may implement multiple processor threads and/or multiple processor cores. Cache 908 is memory that is located in the processor chip package(s) and is typically used for data or code that should be available for rapid access by the threads or cores running on processor set 906. Cache memories are typically organized into multiple levels depending upon relative proximity to the processing circuitry. Alternatively, some, or all, of the cache for the processor set may be located “off chip.” In some computing environments, processor set 906 may be designed for working with qubits and performing quantum computing.

Computer readable program instructions are typically loaded onto classical computer 102 to cause a series of operational steps to be performed by processor set 906 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 908 and the other storage media discussed below. The program instructions, and associated data, are accessed by processor set 906 to control and direct performance of the inventive methods. In computing environment 900, at least some of the instructions for performing the inventive methods may be stored in block 901 in persistent storage 911.

Communication fabric 909 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 910 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 910 is located in a single package and is internal to classical computer 102, but, alternatively or additionally, the volatile memory may be distributed over multiple packages and/or located externally with respect to classical computer 102.

Persistent Storage 911 is any form of non-volatile storage for computers that is now known or to be developed in the future. The non-volatility of this storage means that the stored data is maintained regardless of whether power is being supplied to classical computer 102 and/or directly to persistent storage 911. Persistent storage 911 may be a read only memory (ROM), but typically at least a portion of the persistent storage allows writing of data, deletion of data and re-writing of data. Some familiar forms of persistent storage include magnetic disks and solid state storage devices. Operating system 912 may take several forms, such as various known proprietary operating systems or open source Portable Operating System Interface type operating systems that employ a kernel. The code included in block 901 typically includes at least some of the computer code involved in performing the inventive methods.

Peripheral device set 913 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 914 may include components such as a display screen, speaker, microphone, wearable devices (such as goggles and smart watches), keyboard, mouse, printer, touchpad, game controllers, and haptic devices. Storage 915 is external storage, such as an external hard drive, or insertable storage, such as an SD card. Storage 915 may be persistent and/or volatile. In some embodiments, storage 915 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 916 is made up of sensors that can be used in Internet of Things applications. For example, one sensor may be a thermometer and another sensor may be a motion detector.

Network module 917 is the collection of computer software, hardware, and firmware that allows classical computer 102 to communicate with other computers through WAN 113. Network module 917 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 917 are performed on the same physical hardware device. In other embodiments (for example, embodiments that utilize software-defined networking (SDN)), the control functions and the forwarding functions of network module 917 are performed on physically separate devices, such that the control functions manage several different network hardware devices. Computer readable program instructions for performing the inventive methods can typically be downloaded to classical computer 102 from an external computer or external storage device through a network adapter card or network interface included in network module 917.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 902 is any computer system that is used and controlled by an end user (for example, a customer of an enterprise that operates classical computer 102), and may take any of the forms discussed above in connection with classical computer 102. EUD 902 typically receives helpful and useful data from the operations of classical computer 102. For example, in a hypothetical case where classical computer 102 is designed to provide a recommendation to an end user, this recommendation would typically be communicated from network module 917 of classical computer 102 through WAN 113 to EUD 902. In this way, EUD 902 can display, or otherwise present, the recommendation to an end user. In some embodiments, EUD 902 may be a client device, such as thin client, heavy client, mainframe computer, desktop computer and so on.

Remote server 903 is any computer system that serves at least some data and/or functionality to classical computer 102. Remote server 903 may be controlled and used by the same entity that operates classical computer 102. Remote server 903 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 918 of remote server 903.

Public cloud 904 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 904 is performed by the computer hardware and/or software of cloud orchestration module 920. The computing resources provided by public cloud 904 are typically implemented by virtual computing environments that run on various computers making up the computers of host physical machine set 921, which is the universe of physical computers in and/or available to public cloud 904. The virtual computing environments (VCEs) typically take the form of virtual machines from virtual machine set 922 and/or containers from container set 923. It is understood that these VCEs may be stored as images and may be transferred among and between the various physical machine hosts, either as images or after instantiation of the VCE. Cloud orchestration module 920 manages the transfer and storage of images, deploys new instantiations of VCEs and manages active instantiations of VCE deployments. Gateway 919 is the collection of computer software, hardware, and firmware that allows public cloud 904 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 905 is similar to public cloud 904, except that the computing resources are only available for use by a single enterprise. While private cloud 905 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 904 and private cloud 905 are both part of a larger hybrid cloud.

Block 901 further includes the software components discussed above in connection with FIGS. 2-8 to improve the quantum computing process by training a neural network to predict a probability distribution outputted by a quantum computer based on running a quantum circuit. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for improving the quantum computing process by training a neural network to predict a probability distribution outputted by a quantum computer based on running a quantum circuit, may be embodied in an application specific integrated circuit.

As stated above, quantum computing utilizes quantum circuits, which are graphical representations of a sequence of quantum gates and measurements that perform a quantum computation. Quantum circuits are used to carry out unitary transformations on qubits. Qubits or quantum bits, are the basic unit of information in quantum computing. It is the quantum equivalent of the bit, or binary digit, used in classical computing. In order to run quantum circuits on quantum computers, especially large quantum circuits (quantum circuits with a large depth, which corresponds to the count of time steps needed to execute all the gates in the quantum circuit), such quantum circuits need to be classically simplified which is a lengthy and difficult process to implement. Furthermore, quantum circuits are often simulated to assist in developing algorithms, evaluating hardware, understanding noise resilience, etc. However, such simulators (software program that uses a classical computer to simulate the quantum operations of a quantum computer) have difficulty in simulating quantum circuits with a significant number of qubits (e.g., greater than 60 qubits). That is, due to the significant amount of classical resources required to simulate quantum circuits with a significant number of qubits (e.g., greater than 60 qubits), such quantum circuits may not be able to be simulated. Additionally, quantum workloads, such as utility-scale iterative workloads, may take tens of hours to run from start to finish. Utility-scale iterative workloads are workloads that include tasks that are repeated until a desired outcome is achieved for quantum utility, which is when a quantum computer is able to reliably solve problems at a scale that is beyond the capabilities of traditional classical computers using brute force methods. As a result, processing such utility-scale iterative workloads requires lots of quantum processing unit time and parameter updates (parameters are variables that may be used to optimize a function, maximize an objective, or solve a specific problem). Furthermore, given a quantum circuit, it is difficult to verify whether that quantum circuit has been run correctly on a specific backend of the quantum computer. The backend of the quantum computer is a simulator or a real quantum computer that runs quantum circuits and returns results. As a result, the quantum computing process is subject to various shortcomings, such as the difficulty in simplifying large quantum circuits, simulating quantum circuits with a significant number of qubits, processing utility-scale iterative workloads, and verifying that the quantum circuit has been run correctly on a specific backend of the quantum computer.

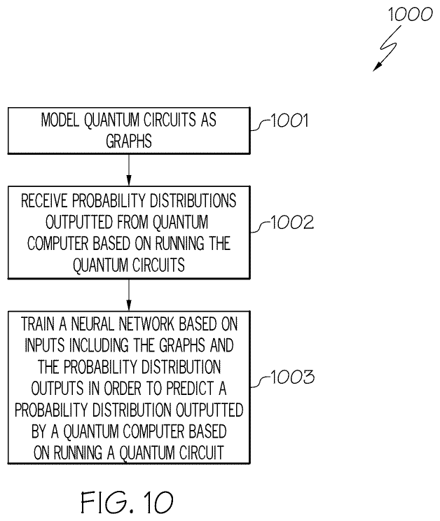

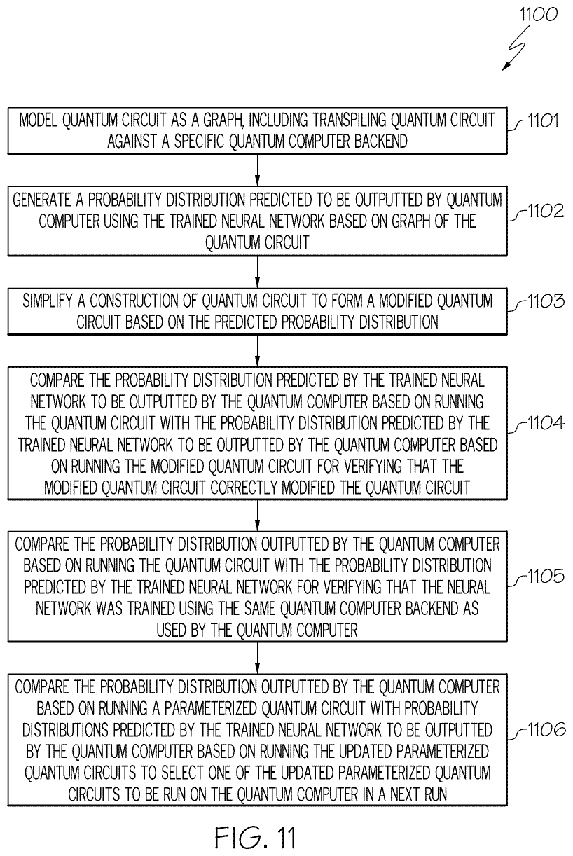

The embodiments of the present disclosure provide the means for improving the quantum computing process by training a neural network to predict a probability distribution outputted by a quantum computer based on running a quantum circuit as discussed below in connection with FIGS. 10-11. FIG. 10 is a flowchart of a method for training a neural network to predict the probability distribution of a quantum computer. FIG. 11 is a flowchart of a method for utilizing a trained neural network to improve the quantum computing process.

As stated above, FIG. 10 is a flowchart of a method 1000 for training a neural network to predict the probability distribution of a quantum computer in accordance with an embodiment of the present disclosure.

Referring to FIG. 10, in conjunction with FIGS. 1-9, in step 1001, modeling engine 202 of classical computer 102 models quantum circuits (e.g., quantum circuits 109) as graphs.

As stated above, in one embodiment, modeling engine 202 models quantum circuits (e.g., quantum circuits 109) as graphs by representing each qubit as a node, and each quantum gate as an edge connecting the relevant qubit nodes, where the edge direction indicates the order of operations in the circuit, essentially treating the circuit diagram as a directed acyclic graph (DAG) with the flow of information from left to right. In such an embodiment, each gate will be connected to the qubits it operates on as input and output nodes.

In one embodiment, modeling engine 202 models the quantum circuits (e.g., quantum circuits 109) as graphs using various software tools, such as, but not limited to, transpiler 112.

In step 1002, machine learning engine 201 of classical computer 102 receives probability distributions outputted from quantum computer 101 based on running the quantum circuits (the quantum circuits that were modeled as graphs).

As discussed above, a probability distribution, as used herein, refers to a mathematical function that describes the likelihood of different possible outcomes for a given input, i.e., representing a range of potential predictions.

In one embodiment, machine learning engine 201 obtains the probability distributions from the quantum computer (e.g., quantum computer 101) from measuring engine 203 by measuring engine 203 measuring the quantum state, where the probability of each possible outcome is directly related to the square of the amplitude of the corresponding quantum state vector. In one embodiment, measuring engine 203 utilizes various software tools for measuring the probability distributions outputted by a quantum computer based on running quantum circuits, such as, but not limited to, Qiskit, ®, Cirq®, ProjectQ, etc.

As previously discussed, the quantum circuits modeled as graphs as well as the probability distributions outputted from quantum computer 101 are used as a sample data set to train a neural network to predict a probability distribution outputted by quantum computer 101 based on running a quantum circuit (e.g., quantum circuit 109) as discussed below.

In step 1003, machine learning engine 201 of classical computer 102 trains a neural network based on a sample data set (inputs) including the quantum circuits modeled as graphs as well as the probability distributions outputted from quantum computer 101 in order to predict a probability distribution outputted by a quantum computer (e.g., quantum computer 101) based on running a quantum circuit (e.g., quantum circuit 109).

As stated above, an illustration of training a neural network based on such a sample data set (graphs of quantum circuits and probability distributions outputted by the quantum computer based on running such quantum circuits) is provided in FIG. 3.

As shown in FIG. 3, neural network (NN) 301 is trained based on quantum circuits 109 modeled as graphs and probability distributions (PD) 302 outputted by quantum computer (QC) 101 based on running quantum circuits 109 that were modeled as graphs.

In one embodiment, the sample data set further includes calibration data and a qubit coupling map, such as in the form of a graph.

Calibration data, as used herein, refers to information collected about the performance of quantum computer 101 during calibration, which is used to adjust the parameters of the quantum gates and qubits to improve the fidelity (measure of how closely a quantum state or operation matches its intended or ideal state or operation) of quantum operations. In one embodiment, machine learning engine 201 obtains such calibration data from measuring engine 203 based on measuring engine 203 monitoring the performance of quantum computer 101 during calibration using techniques, such as randomized benchmarking (RB) and quantum process tomography, to measure the fidelity of quantum gates, and analyzing metrics from such monitored performance, such as error rates and qubit coherence times, while observing the data through the quantum computer's control interface to identify any anomalies or drifts in performance across individual qubits and gate operations. This allows for adjustments to calibration parameters to optimize the system's overall performance. In one embodiment, measuring engine 203 measures such calibration data in such a manner using various software tools including, but are not limited to, Cirq®, Qiskit®, Qibocal, etc.

A qubit coupling map, as used herein, refers to a directed graph that shows which qubits can interact with each other in quantum computer 101. In one embodiment, the nodes in the qubit coupling map represent physical qubits and the directed edges represent permitted CNOT gates. In one embodiment, machine learning engine 201 uses the CouplingMap function of Qiskit® to generate such a qubit coupling map for quantum hardware (e.g., quantum computer 101).

In one embodiment, the sample data set, discussed herein, is obtained by an expert, such as a developer.

Furthermore, in one embodiment, the sample data set discussed above is referred to herein as the “training data,” which is used by a machine learning algorithm to make predictions or decisions, such as the predicted probability distribution outputted by a quantum computer (e.g., quantum computer 101) based on running a quantum circuit (e.g., quantum circuit 109). In one embodiment, as discussed further below, the trained neural network predicts the probability distribution outputted by the quantum computer (e.g., quantum computer 101) based on the input of the quantum circuit being modeled as a graph. The algorithm iteratively makes predictions on the training data until the predictions achieve the desired accuracy as determined by an expert.

In one embodiment, machine learning engine 201 creates an intermediate layer in the neural network (e.g., neural network 301) to model a density matrix of the quantum computer (e.g., quantum computer 101). A density matrix, as used herein, is a matrix that represents quantum states in quantum computing and quantum mechanics. It is a generalization of wavefunctions and state vectors, which can only represent pure states, while density matrices can also represent mixed ensembles. In such a density matrix, the diagonal entries of the density matrix represent the probabilities of each classical state appearing in a standard basis measurement. The off-diagonal entries describe the degree to which the two classical states corresponding to that entry are in quantum superposition. In one embodiment, machine learning engine 201 creates such an intermediate layer using various software tools, including, but are not limited to, IBM® Quantum Platform®, Intel® Quantum Simulator, Cirq®, etc.

In one embodiment, machine learning engine 201 takes into consideration the constraints (e.g., positive semidefinite, trace(matrix)=1) of a correct (physical) density by adding an additional (filter) layer.

In one embodiment, machine learning engine 201 adds an additional layer to model the transformation on the density matrix due to noise, such as in the Kraus channel. The Kraus representation of a quantum channel is a collection of matrices that describe how the density matrix evolves.

In one embodiment, machine learning engine 201 filters the results of the neural network (e.g., neural network 301) based on outputs summing to 1. In one embodiment, such filtering occurs in a final filter layer to ensure that a correct probability distribution is outputted by the quantum computer.

Upon training the neural network (e.g., neural network 301), the trained neural network predicts the probability distribution outputted by the quantum computer (e.g., quantum computer 101) based on the input of the quantum circuit being modeled as a graph as discussed below in connection with FIG. 11.

FIG. 11 is a flowchart of a method 1100 for utilizing a trained neural network to improve the quantum computing process in accordance with an embodiment of the present disclosure.

Referring to FIG. 11, in conjunction with FIGS. 1-10, in step 1101, modeling engine 202 of classical computer 102 models the quantum circuit to be inputted to the trained neural network (e.g., trained neural network 401) as a graph.

As discussed above, in one embodiment, modeling engine 202 models the quantum circuit (e.g., quantum circuit 109) as a graph by representing each qubit as a node, and each quantum gate as an edge connecting the relevant qubit nodes, where the edge direction indicates the order of operations in the circuit, essentially treating the circuit diagram as a directed acyclic graph (DAG) with the flow of information from left to right. In such an embodiment, each gate will be connected to the qubits it operates on as input and output nodes.

In one embodiment, modeling engine 202 models the quantum circuit (e.g., quantum circuit 109) as a graph using various software tools, such as, but not limited to, transpiler 112.

In one embodiment, modeling engine 202 transpiles the quantum circuit against a specific quantum computer backend. A quantum computer backend, as used herein, is a simulator or real quantum computer that runs quantum circuits and returns results. Backends can have properties that change when calibrated, such as qubit frequency and operation error rates.

In one embodiment, generating engine 204 of classical computer 102 receives a graph of the modeled quantum circuit (e.g., quantum circuit 109), including the graph of a transpiled quantum computer, from modeling engine 202.

In step 1102, generating engine 204 of classical computer 102 generates a probability distribution predicted to be outputted by the quantum computer (e.g., quantum computer 101) using the trained neural network (e.g., trained neural network 401) based on the received graph of the quantum circuit (e.g., quantum circuit 109), including a quantum circuit that was transpiled against a specific quantum computer backend, as illustrated in FIG. 4.

Referring to FIG. 4, the trained neural network 401 receives the graph of quantum circuit 109, including the graph of the quantum circuit transpiled against a specific quantum computer backend. Upon receiving such an input, the trained neural network (NN) 401 outputs the probability distribution (PD) 402 predicted to be outputted by quantum computer 101 based on running such a quantum circuit.

In this manner, the trained neural network (e.g., trained neural network 401) functions as a simulator to predict the probability distribution outputted by the quantum computer (e.g., quantum computer 101) based on the modeled quantum circuit (modeled as a graph). As a result, results for large quantum circuits may now be able to be predicted for such quantum circuits that were not previously simulatable. For example, quantum circuits with a significant number of qubits (e.g., greater than 60 qubits) may not previously have been able to be simulated due to the significant amount of required classical resources. Such quantum circuits with a significant number of qubits may now be able to be simulated via the trained neural network (e.g., trained neural network 401).

Furthermore, in this manner, by predicting the probability distribution 402 outputted by quantum computer 101, such a probability distribution may be used to simplify the construction of the quantum circuit (e.g., quantum circuit 109) as discussed below.

In step 1103, generating engine 204 of classical computer 102 simplifies the construction of the quantum circuit (e.g., quantum circuit 109) to form a modified quantum circuit based on the predicted probability distribution.

As discussed above, in one embodiment, generating engine 204 simplifies the construction of the quantum circuit (e.g., quantum circuit 109) to form a modified quantum circuit based on the predicted probability distribution as shown in FIG. 5.

Referring to FIG. 5, generating engine 204 generates a modified quantum circuit 501 with a simpler design than quantum circuit 109 based on the probability distribution 402 predicted by the trained neural network 401.

In one embodiment, generating engine 204 simplifies the construction of quantum circuit 109 to form modified quantum circuit 501 based on the predicted probability distribution 402 using one or more of the following methods: light-cone method, circuit cutting and forging technique, and Clifford circuit approximation.

The light-cone method, as used herein, refers to a technique, based on the concept of a light cone from special relativity, used to limit calculations to events that can influence each other within a specific boundary thereby allowing for more efficient computation (reduction in the number of qubits) by restricting the relevant interactions within the system.

The circuit cutting and forging technique is a technique to break down quantum circuits into smaller circuits that can be run on quantum hardware. Circuit cutting is the technique to break down a quantum circuit into smaller circuits by cutting its wires and gates. The results of the smaller circuits are then combined to reconstruct the original circuit's outcome. Circuit cutting can also be used to engineer gates between distant qubits.

Entanglement forging is a technique that allows a larger circuit to be cut into smaller circuits that can be run on smaller hardware. Smaller circuits are easier to execute and can tolerate more noise.

Clifford approximation, as used herein, refers to a method for approximating quantum circuits using a restricted class of quantum circuits called Clifford circuits.

Generating engine 204 uses various software tools for simplifying the construction of quantum circuit 109 to form modified quantum circuit 501 based on the probability distribution predicted by the trained neural network 401, including, but are not limited to, ProjectQ, Cirq®, Qiskit®, PennyLane®, IBM® Quantum Platform®, etc.

By being able to simplify the construction of quantum circuits, large quantum circuits may be more accessible to current quantum hardware.

Furthermore, by training the neural network (e.g., trained neural network 401) to predict the probability distribution outputted by the quantum computer (e.g., quantum computer 101), it can be verified that modified quantum circuit 501 (e.g., quantum circuit modified by circuit cutting and forging technique) is accurate without needing to access the quantum computer as discussed below.

In step 1104, generating engine 204 of classical computer 102 compares the probability distribution predicted by the trained neural network (e.g., trained neural network 401) to be outputted by the quantum computer (e.g., quantum computer 101) based on running the quantum circuit (e.g., quantum circuit 109) with the probability distribution predicted by the trained neural network (e.g., trained neural network 401) to be outputted by the quantum computer (e.g., quantum computer 101) based on running the modified quantum circuit (e.g., modified quantum circuit 501) for verifying that the modified quantum circuit (e.g., modified quantum circuit 501) correctly modified the quantum circuit (e.g., quantum circuit 109).

As stated above, for example, the probability distribution predicted by the trained neural network (e.g., trained neural network 401) for both modified quantum circuit 501 and the non-modified quantum circuit 109 can be compared. If such a difference is below a threshold value, which may be user-designated, then it may be concluded that modified quantum circuit 501 correctly modified quantum circuit 109 as discussed below in connection with FIG. 6.

Referring to FIG. 6, in conjunction with FIGS. 2-5, generating engine 204 compares (see element 601) the probability distribution 402′ predicted by the trained neural network (e.g., trained neural network 401) for the quantum circuit 109 with the probability distribution 402″ predicted by the trained neural network (e.g., trained neural network 401) for modified quantum circuit 501. As previously discussed, modified quantum circuit 501 is a simplified version of quantum circuit 109, which was simplified using the light-cone method, the circuit cutting and forgoing technique, or the Clifford circuit approximation.

In one embodiment, generating engine 204 performs such a comparison by calculating the Hellinger distance, such as by using the hellinger1 program or the function qiskit.quantum_info.hellinger_fidelity in Qiskit®, which is used to quantify the similarity between two probability distributions. If the Hellinger distance is below a threshold value, which may be user-designated, then it may be concluded that modified quantum circuit 501 correctly modified quantum circuit 109.

Furthermore, by training the neural network (e.g., trained neural network 401) to predict the probability distribution outputted by the quantum computer (e.g., quantum computer 101), it can be verified that the quantum circuit has been run correctly on a specific backend of the quantum computer as discussed below.

In step 1105, generating engine 204 of classical computer 101 compares the probability distribution outputted by the quantum computer (e.g., quantum computer 101) based on running the quantum circuit with the probability distribution predicted by the trained neural network (e.g., trained neural network 401) for verifying that the neural network was trained (e.g., trained neural network 401) using the same quantum computer backend as used by the quantum computer as discussed below in connection with FIG. 7.

As discussed above, referring to FIG. 7, in conjunction with FIGS. 2-5, generating engine 204 compares (see element 701) the probability distribution 302′ outputted by quantum computer 101 based on quantum circuit 109 running on quantum computer 101 with the probability distribution 402″′ predicted by the trained neural network (e.g., trained neural network 401) based on receiving a graph of the modeled quantum circuit 109, which may have been transpiled against a specific computer backend.

In one embodiment, generating engine 204 performs such a comparison by calculating the Hellinger distance, such as by using the hellinger1 program or the function qiskit.quantum_info.hellinger_fidelity in Qiskit®, which is used to quantify the similarity between two probability distributions. If the Hellinger distance is below a threshold value, which may be user-designated, then it may be concluded that the probability distribution (e.g., probability distribution 402″′) predicted by the trained neural network was trained on the same quantum computer backend as was used by quantum computer 101 to output its probability distribution.

Furthermore, such a trained neural network (e.g., trained neural network 401) may be utilized for improving the speed in processing iterative workloads (e.g., utility-scale iterative workloads) as discussed below.

In step 1106, generating engine 204 of classical computer 101 compares the probability distribution outputted by the quantum computer (e.g., quantum computer 101) based on running a parameterized quantum circuit with the probability distributions predicted by the trained neural network (e.g., trained neural network 401) to be outputted by the quantum computer (e.g., quantum computer 101) based on running the updated parameterized quantum circuits to select one of the updated parameterized quantum circuits to be run on the quantum computer (e.g., quantum computer) in a next run as discussed below in connection with FIG. 8.

As stated above, referring to FIG. 8, the trained neural network (e.g., trained neural network 401) receives as inputs, updated parameterized quantum circuits 802A-802C, which have parameters updated from an original parameterized quantum circuit 801.

A parameterized quantum circuit 801, 802, as used herein, is a quantum circuit that contains both fixed and adjustable gates. The adjustable gates, or parameters, can be changed during computation to solve problems or perform tasks. An updated parameterized quantum circuit 802 corresponds to parameterized quantum circuit 801 with an update to one or more parameters of parameterized quantum circuit 801.

In one embodiment, modeling engine 202 models updated parameterized quantum circuits 802 as graphs in the same manner as modeling quantum circuit 109 as a graph discussed above. Upon receiving such graphs as inputs, the trained neural network (e.g., neural network 401) outputs predicted probability distributions 402″″ for each updated parameterized quantum circuit 802 which are evaluated against the probability distribution 302″ outputted by quantum computer 101 running parameterized quantum circuit 801, such as on the first run.

In one embodiment, such an evaluation is performed by generating engine 204 using a cost function 803, which is a measure of how well a model fits the data and how close its predictions are to the desired outcomes. The cost function is used to evaluate the probability distributions predicted by the trained neural network (e.g., neural network 401) for each of the inputted updated parameterized quantum circuits 802 in comparison to the probability distribution outputted by quantum computer 101. The closer such probability distributions, the closer the associated updated parameterized quantum circuit 802 is to the original parameterized quantum circuit 801, which should be used in further iterations to process the iterative workflow in order to improve the time for processing long-running workflows, such as utility-scale iterative workflows. Examples of cost functions utilized by generating engine 204 to evaluate how close the probability distributions predicted by the trained neural network (e.g., neural network 401) for each of the inputted updated parameterized quantum circuits 802 is to the probability distribution outputted by quantum computer 101 include, but are not limited to, Kullback-Leibler divergence (KLD), Jensen-Shannon Divergence, Wasserstein Distance, Kolmogorov-Smirnov Test, Chi-Squared Test, etc.

After identifying one of the updated parameterized quantum circuits 802A-802C with its predicted probability distribution 402″″ as most closely matching the probability distribution 302″ outputted by quantum computer 101, such an identified updated parameterized quantum circuit 802 is selected as the best parameterized quantum circuit 804 to be utilized by quantum computer 101 in its next run in processing the iterative workload (e.g., utility-scale iterative workflow). Quantum computer 101 then runs the best parameterized quantum circuit 804 in the next run thereby outputting probability distribution 302″′.

It is noted that such a probability distribution 302″′ may be evaluated against the updated parameterized quantum circuits 802A-802C with its predicted probability distribution 402″″ in the next run to determine if parameterized quantum circuit 804 is still the best parameterized quantum circuit to be utilized by quantum computer 101 in its next run in processing the iterative workload (e.g., utility-scale iterative workflow). By selecting the best parameterized quantum circuit to process long-running algorithms, the time for processing long-running workflows, such as utility-scale iterative workflows, is improved.

In this manner, the shortcomings to the quantum computing process are overcome, such as overcoming the difficulty in simplifying large quantum circuits, simulating quantum circuits with a significant number of qubits, processing utility-scale iterative workloads, and verifying that the quantum circuit has been run correctly on a specific backend of the quantum computer.

Furthermore, the principles of the present disclosure improve the technology or technical field involving quantum computing.

As discussed above, quantum computing utilizes quantum circuits, which are graphical representations of a sequence of quantum gates and measurements that perform a quantum computation. Quantum circuits are used to carry out unitary transformations on qubits. Qubits or quantum bits, are the basic unit of information in quantum computing. It is the quantum equivalent of the bit, or binary digit, used in classical computing. In order to run quantum circuits on quantum computers, especially large quantum circuits (quantum circuits with a large depth, which corresponds to the count of time steps needed to execute all the gates in the quantum circuit), such quantum circuits need to be classically simplified which is a lengthy and difficult process to implement. Furthermore, quantum circuits are often simulated to assist in developing algorithms, evaluating hardware, understanding noise resilience, etc. However, such simulators (software program that uses a classical computer to simulate the quantum operations of a quantum computer) have difficulty in simulating quantum circuits with a significant number of qubits (e.g., greater than 60 qubits). That is, due to the significant amount of classical resources required to simulate quantum circuits with a significant number of qubits (e.g., greater than 60 qubits), such quantum circuits may not be able to be simulated. Additionally, quantum workloads, such as utility-scale iterative workloads, may take tens of hours to run from start to finish. Utility-scale iterative workloads are workloads that include tasks that are repeated until a desired outcome is achieved for quantum utility, which is when a quantum computer is able to reliably solve problems at a scale that is beyond the capabilities of traditional classical computers using brute force methods. As a result, processing such utility-scale iterative workloads requires lots of quantum processing unit time and parameter updates (parameters are variables that may be used to optimize a function, maximize an objective, or solve a specific problem). Furthermore, given a quantum circuit, it is difficult to verify whether that quantum circuit has been run correctly on a specific backend of the quantum computer. The backend of the quantum computer is a simulator or a real quantum computer that runs quantum circuits and returns results. As a result, the quantum computing process is subject to various shortcomings, such as the difficulty in simplifying large quantum circuits, simulating quantum circuits with a significant number of qubits, processing utility-scale iterative workloads, and verifying that the quantum circuit has been run correctly on a specific backend of the quantum computer.

Embodiments of the present disclosure improve such technology by modeling quantum circuits as graphs. In one embodiment, quantum circuits are modeled as graphs by representing each qubit as a node, and each quantum gate as an edge connecting the relevant qubit nodes, where the edge direction indicates the order of operations in the circuit. Furthermore, probability distributions outputted from a quantum computer based on running the quantum circuits are received. A probability distribution, as used herein, refers to a mathematical function that describes the likelihood of different possible outcomes for a given input, i.e., representing a range of potential predictions. A neural network is then trained based on a sample data set (inputs) including the quantum circuits modeled as graphs as well as the probability distributions outputted from the quantum computer in order to predict a probability distribution outputted by the quantum computer based on running a quantum circuit. Such a predicted probability distribution by the trained neural network is then used to improve the quantum computing process by enabling the construction of the quantum circuit to be simplified, enabling the simulation of the quantum circuit with a significant number of qubits, improving the time in processing an iterative workload, verifying that a given quantum circuit has been run correctly on a specific quantum computer backend, etc. Furthermore, in this manner, there is an improvement in the technical field involving quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for utilizing a neural network to improve quantum computing process, the method comprising:
modeling quantum circuits as graphs;
receiving probability distributions outputted from a quantum computer based on running said quantum circuits; and
training said neural network based on inputs comprising said graphs and said probability distributions in order to predict a probability distribution outputted by said quantum computer based on running a quantum circuit.

2. The method as recited in claim 1, wherein said inputs further comprise calibration data and qubit coupling maps.

3. The method as recited in claim 1, wherein said trained neural network functions as a simulator to predict said probability distribution outputted by said quantum computer based on a graph of said quantum circuit.

4. The method as recited in claim 1 further comprising:
comparing a probability distribution outputted by said quantum computer based on running a parameterized quantum circuit with probability distributions predicted by said trained neural network to be outputted by said quantum computer based on running updated parameterized quantum circuits to select one of said updated parameterized quantum circuits to be run on said quantum computer in a next run.

5. The method as recited claim 1 further comprising:
simplifying a construction of said quantum circuit to form a modified quantum circuit based on said predicted probability distribution outputted by said quantum computer using one or more of the following methods in the group consisting of: light-cone method, circuit cutting and forging technique, and Clifford circuit approximation.

6. The method as recited in claim 1 further comprising:
comparing said probability distribution predicted by said trained neural network to be outputted by said quantum computer based on running said quantum circuit with a probability distribution predicted by said trained network to be outputted by said quantum computer based on running a modified quantum circuit for verifying that said modified quantum circuit correctly modified said quantum circuit.

7. The method as recited in claim 1 further comprising:
comparing a probability distribution outputted by said quantum computer based on running said quantum circuit with said probability distribution predicted by said trained neural network to be outputted by said quantum computer based on running said quantum circuit for verifying that said neural network was trained using a same quantum computer backend as used by said quantum computer.

8. The method as recited in claim 1 further comprising:
creating an intermediate layer of said neural network to model a density matrix of said quantum computer; and
filtering a result based on outputs summing to 1.

9. A computer program product for utilizing a neural network to improve quantum computing process, the computer program product comprising one or more computer readable storage mediums having program code embodied therewith, the program code comprising programming instructions for:
modeling quantum circuits as graphs;
receiving probability distributions outputted from a quantum computer based on running said quantum circuits; and
training said neural network based on inputs comprising said graphs and said probability distributions in order to predict a probability distribution outputted by said quantum computer based on running a quantum circuit.

10. The computer program product as recited in claim 9, wherein said inputs further comprise calibration data and qubit coupling maps.

11. The computer program product as recited in claim 9, wherein said trained neural network functions as a simulator to predict said probability distribution outputted by said quantum computer based on a graph of said quantum circuit.

12. The computer program product as recited in claim 9, wherein the program code further comprises the programming instructions for:
comparing a probability distribution outputted by said quantum computer based on running a parameterized quantum circuit with probability distributions predicted by said trained neural network to be outputted by said quantum computer based on running updated parameterized quantum circuits to select one of said updated parameterized quantum circuits to be run on said quantum computer in a next run.

13. The computer program product as recited claim 9, wherein the program code further comprises the programming instructions for:
simplifying a construction of said quantum circuit to form a modified quantum circuit based on said predicted probability distribution outputted by said quantum computer using one or more of the following methods in the group consisting of: light-cone method, circuit cutting and forging technique, and Clifford circuit approximation.

14. The computer program product as recited in claim 9, wherein the program code further comprises the programming instructions for:
comparing said probability distribution predicted by said trained neural network to be outputted by said quantum computer based on running said quantum circuit with a probability distribution predicted by said trained network to be outputted by said quantum computer based on running a modified quantum circuit for verifying that said modified quantum circuit correctly modified said quantum circuit.

15. The computer program product as recited in claim 9, wherein the program code further comprises the programming instructions for:
comparing a probability distribution outputted by said quantum computer based on running said quantum circuit with said probability distribution predicted by said trained neural network to be outputted by said quantum computer based on running said quantum circuit for verifying that said neural network was trained using a same quantum computer backend as used by said quantum computer.

16. A system, comprising:
a memory for storing a computer program for utilizing a neural network to improve quantum computing process; and
a processor connected to said memory, wherein said processor is configured to execute program instructions of the computer program comprising:
modeling quantum circuits as graphs;
receiving probability distributions outputted from a quantum computer based on running said quantum circuits; and
training said neural network based on inputs comprising said graphs and said probability distributions in order to predict a probability distribution outputted by said quantum computer based on running a quantum circuit.

17. The system as recited in claim 16, wherein said inputs further comprise calibration data and qubit coupling maps.

18. The system as recited in claim 16, wherein said trained neural network functions as a simulator to predict said probability distribution outputted by said quantum computer based on a graph of said quantum circuit.

19. The system as recited in claim 16, wherein the program instructions of the computer program further comprise:
comparing a probability distribution outputted by said quantum computer based on running a parameterized quantum circuit with probability distributions predicted by said trained neural network to be outputted by said quantum computer based on running updated parameterized quantum circuits to select one of said updated parameterized quantum circuits to be run on said quantum computer in a next run.

20. The system as recited claim 16, wherein the program instructions of the computer program further comprise:
simplifying a construction of said quantum circuit to form a modified quantum circuit based on said predicted probability distribution outputted by said quantum computer using one or more of the following methods in the group consisting of: light-cone method, circuit cutting and forging technique, and Clifford circuit approximation.
